(19) United States
(12) Patent Application Publication
(10) Pub. No.: US 2013/0130060 A1
(43) Pub. Date: May 23, 2013

(54) TRANSPARENT CONDUCTIVE FILMS AND METHODS FOR MANUFACTURING THE SAME

(71) Applicants: Shin-Liang KUO, Taipei City (TW); Cheng-Jyun Huang, Pingzhen City (TW); Shu-Jiuan Huang, Taipei City (TW)

(72) Inventors: Shin-Liang KUO, Taipei City (TW); Cheng-Jyun Huang, Pingzhen City (TW); Shu-Jiuan Huang, Taipei City (TW)

(21) Appl. No.: 13/363,987

(22) Filed: Feb. 1, 2012

(30) Foreign Application Priority Data
Nov. 23, 2011 (TW) 100142878

(51) Int. Cl. B05D 5/12; B44C 1/17; H01B 1/04; B32B 9/00; B82Y 30/00

(52) U.S. Cl. 428/688; 252/502; 252/510; 427/122; 156/230; 977/742; 977/734; 977/750

(57) ABSTRACT

Disclosed is a transparent conductive film including a substrate, and a conductive composite on the substrate, wherein the conductive composite includes conductive carbon material and a non-carbon inorganic material having a surface modified by an electron-withdrawing group, and the non-carbon inorganic material contacts the conductive carbon material. Furthermore, the disclosed provides a method of manufacturing the transparent conductive film.

### CROSS REFERENCE TO RELATED APPLICATIONS

This application claims priority of Taiwan Patent Application No. 100142878, filed on Nov. 23, 2011, the entirety of which is incorporated by reference herein.

### BACKGROUND OF THE INVENTION

1. Field of the Invention

The disclosure relates to a transparent conductive film based on a carbon material, and in particular relates to a structure and a method of manufacturing the same.

2. Description of the Related Art

The carbon nanotube discovered by Ijima in 1991 has individual physical and chemical properties, thereby being potential in several zones such as being a conductive additive in electromagnetic shielding and electrostatic discharging elements, an electrode of an energy storage element (e.g. lithium secondary battery, super high capacitor, fuel cell, etc.), an adsorption material, a catalyst carrier, a thermally conductive material, and the likes. The costly tin-doped indium oxide (ITO) is limited to application in large area and the flexible electronic industry is grown, such that the nano carbon material having high electric conductivity, low visible light absorption, and high mechanical strength is important to flexible, transparent, and conductive films. For example, the conductivity of a transparent conductive film based on a carbon nanotube is determined by inherent conductivity, dispersion degree, and the network stack of the carbon nanotube. The electrical properties of different carbon nanotubes prepared by different methods are largely varied by several orders. A single-walled or double-walled carbon nanotube of high purity is preferably selected to achieve better film conductivity. The selection and purity of the carbon source may enhance properties of the transparent conductive film, as well as compounding the carbon material with poly(3,4-ethylenedioxythiophene (PEDOT), nano metal, or conductive oxide. Meanwhile, the trend of enhancing conductivity of the conductive film based on a carbon material is chemical doping.

In Nature, 388, 255 (1997), a conductive film based on a carbon material is chemically doped by potassium vapor and halogen (Br₂) vapor to largely reduce the electrical resistance of the carbon nanotube. However, most of the product is unstable in air.

In U.S. Pat. No. 6,139,919, the single-walled carbon nanotube is directly dipped in melted iodine for doping. The I₂ molecule is decomposed to be I⁺ and I₃⁻ for being charge transferred with the carbon nanotube. The sheet resistance of a film based on the doped carbon nanotube is less (one order) than that of a film based on the non-doped carbon nanotube. Moreover, the doped carbon nanotube is more stable than a carbon nanotube doped by other halogens.

In J. Am. Chem. Soc. 127, 5125 (2005) and Appl. Phy. Lett., 90, 121913 (2007), the transparent conductive film based on a carbon nanotube is directly treated with SOCl₂ and concentrated HNO₃, thereby not only removing the surface dispersant to achieve a dense network of the carbon nanotube, but also doping the carbon nanotube to reduce the sheet resistance of the film. However, the product is also unstable.

In U.S. Pat. No. 7,253,431, the carbon nanotube is firstly reacted with a one-electron oxidant to change its electrical properties. The oxidant includes organic oxidant, organometallic complex, π-electron acceptor, or silver salt. In U.S. Publication. No. 2008/001141, an organic compound having a strong electron-withdrawing group such as 2,3,5,6-Tetrafluoro-7,7,8,8-Tetracyanoquino-dimethane (TCNQ-F4) is doped to a stack structure formed from a carbon nanotube dispersion, thereby enhancing the conductivity of the carbon nanotube thereof.

In J. Am. Chem. Soc., 130, 2062 (2008), the aromatic and aliphatic organic solvents having different electron-withdrawing groups and electron-donating groups are utilized to change an electron configuration of the single-walled carbon nanotube. As a result, the organic solvent having the electron-withdrawing group may enhance the conductivity of the single-walled carbon nanotube.

In Adv. Func. Mater., 18, 2548 (2008), the conductive film based on a carbon nanotube treated by SOCl₂ and HNO₃ is further coated on a conductive polymer layer (PEDOT-PSS). The above structure is stable in air for over 1500 hours.

In ACS Nano, 4, 6998 (2010), a molecule having a higher boiling point and a strong electro-withdrawing group, e.g. bis(trifluoromethanesulfonyl)amine (TFSA) is utilized to p-type dope the carbon nanotube. The dopant is less volatile at room temperature and therefore extends the stable period of the conductive film based on the doped carbon nanotube.

In Chem. Mater., 22, 5179 (2010), one-electron oxidant such as triethyloxonium hexachloroantimonate (OA) is utilized to p-type dope the carbon nanotube. The dopant OA is a non-volatile salt having a stable doping effect.

In U.S. Publication No. 2010/099815, an electro-withdrawing group (e.g. TCNQ) is covalently bonded to a polymer side chain, such that the polymer should have a stable doping effect for the carbon nanotube. However, the polymer also easily wraps the carbon nanotube, thereby reducing the conductivity of the film based on the carbon nanotube.

Accordingly, the carbon nanotube doped with the dopant by physical or chemical adsorption has low thermal stability. Meanwhile, the carbon nanotube surface wrapped with a protection layer cannot efficiently enhance the thermal stability of the carbon nanotube, and may reduce the conductivity of the carbon nanotube. In other words, there is no conventional doping method which may stably enhance the conductivity of the conductive film based on a carbon material. A chemical doping method and a corresponding structure is still called for improving the conductivity of the conductive film based on the carbon material.

### BRIEF SUMMARY OF THE INVENTION

One embodiment of the disclosure provides a transparent conductive film, comprising: a substrate; and a conductive composite on the substrate, wherein the conductive composite includes: a conductive carbon material; and a non-carbon inorganic material having surface modified by an electron-withdrawing group, wherein the conductive carbon material contacts the non-carbon inorganic material having surface modified by the electron-withdrawing group.

One embodiment of the disclosure provides a method of forming a transparent conductive film, comprising: providing a substrate; and forming a conductive composite on the substrate, wherein the conductive composite includes: a conductive carbon material; and a non-carbon inorganic material having surface modified by an electron-withdrawing group, wherein the conductive carbon material contacts the non-carbon inorganic material having surface modified by the electron-withdrawing group.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIGS. 1-3 show transparent conductive films in embodiments of the disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The disclosure provides a method to efficiently enhance doping stability and stably improve the conductivity of a transparent conductive film. First, a molecule having an electro-withdrawing group is grafted onto a non-carbon inorganic material by a chemical reaction to form a non-carbon inorganic material having surface modified by the electron-withdrawing group. Subsequently, the non-carbon inorganic material having surface modified by the electron-withdrawing group directly contacts a conductive carbon material to form a transparent conductive film. Because the electro-withdrawing group is grafted onto the non-carbon inorganic material, rather than directly being adsorbed on the conductive carbon material, the adhesion, thermal stability, and chemical stability of the electro-withdrawing group are enhanced. In addition, the conductivity of the transparent conductive film containing the conductive carbon material is stably improved.

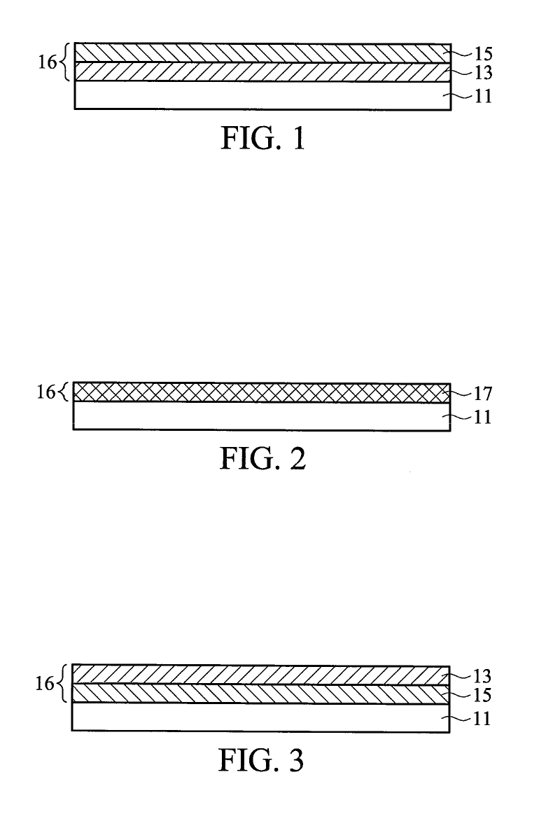

The non-carbon inorganic material having surface modified by the electron-withdrawing group can contact the conductive carbon material by several ways. As shown in FIG. 1, the non-carbon inorganic material having surface modified by the electron-withdrawing group 13 is formed on a substrate 11, and a conductive carbon material 15 is then coated, transfer printed, or vapor deposited thereon. As shown in FIG. 2, the conductive carbon material 15 and the non-carbon inorganic material having surface modified by the electron-withdrawing group 13 are mixed, and the mixture 17 is then coated on the substrate 11. As shown in FIG. 3, the conductive carbon material 15 is coated, transfer printed, or vapor deposited on a substrate 11, and the non-carbon inorganic material having surface modified by the electron-withdrawing group 13 is then formed thereon. In FIG. 3, a part of the non-carbon inorganic material having surface modified by the electron-withdrawing group 13 will permeate into the conductive carbon material 15, such that the non-carbon inorganic material having surface modified by the electron-withdrawing group 13 may help the conductive carbon material 15 to adhere on the substrate 11 surface as well as the structures in FIGS. 1 and 2. The non-carbon inorganic material having surface modified by the electron-withdrawing group 13 may contact the conductive carbon material 15 in any way to construct a conductive composite 16 on the substrate 11. For example, the non-carbon inorganic material having surface modified by the electron-withdrawing group 13 and the conductive carbon material 15 are separated as a layered structure (e.g., multi-layered) or mixed (e.g., homogenously dispersed) to form the conductive composite 16. It should be understood that the layered structure can be other structures (not shown), such as the substrate 11/the non-carbon inorganic material having surface modified by the electron-withdrawing group 13/the conductive carbon material 15/the non-carbon inorganic material having surface modified by the electron-withdrawing group 13, the substrate 11/the conductive carbon material 15/the non-carbon inorganic material having surface modified by the electron-withdrawing group 13/the conductive carbon material 15, the substrate 11/the mixture 17/the conductive carbon material 15, the substrate 11/the conductive carbon material 15/the mixture 17, the substrate 11/the mixture 17/the non-carbon inorganic material having surface modified by the electron-withdrawing group 13, the substrate 11/the non-carbon inorganic material having surface modified by the electron-withdrawing group 13/the mixture 17, or other layered structures.

The substrate 11 can be glass, plastic, synthetic resin, or multi-layered structures thereof. The conductive carbon material 15 can be a carbon nanotube, graphene, graphene oxide, graphene nanoribbon, or combinations thereof. In one embodiment, the conductive carbon material 15 has a size of 0.3 nm to 1000 nm. For example, the carbon nanotube may have a diameter of 0.4 nm to 100 nm, and the graphene, the graphene oxide, and graphene nanoribbon may have a layer number of 1 to 20. A conductive carbon material having an overly large size may absorb too much visible light, such that the transparency of the conductive composite will be reduced.

The non-carbon inorganic material having surface modified by the electron-withdrawing group 13 may have a shape of a pellet, a sheet, a mesh, a film, or combinations thereof. In one embodiment, the non-carbon inorganic material having surface modified by the electron-withdrawing group 13 has a size without specific limitation, preferably of 10 nm to 1000 nm. A non-carbon inorganic material having surface modified by the electron-withdrawing group 13 having an overly small size cannot efficiently form a continuous film with uniform thickness. A non-carbon inorganic material having surface modified by the electron-withdrawing group 13 having an overly large size may lose its transparency. The non-carbon inorganic material having surface modified by the electron-withdrawing group can include oxide, silicate, hydroxide, carbonate, sulfate, phosphate, sulfide, or combinations thereof of silicon, tin, titanium, zinc, aluminum, zirconium, indium, antimony, tungsten, yttrium, magnesium, or cerium having surface modified by the electron-withdrawing group. In one embodiment, the silicate can be smectite clay, vermiculite, metahaloysite, sericite, bentonite, mica, or combinations thereof. For example, the non-carbon inorganic material having surface modified by the electron-withdrawing group 13 can be silica modified by trimethoxy(3,3,3-trifluoropropyl)silane, chloromethyltrimethoxysilane, or 3-(2,4-dinitrophenylamino)propyltriethoxysilane. In one embodiment, the non-carbon inorganic material and the electro-withdrawing group have a weight ratio of 1:0.001 to 1:0.5. The electro-withdrawing group with an overly low ratio cannot achieve the doping effect.

In one embodiment, the non-carbon inorganic material having surface modified by the electron-withdrawing group 13 is formed by reacting a silane having the electro-withdrawing group and the non-carbon inorganic material. The silane has a formula of X—Si(R₁)(R₂)(R₃), wherein X is the electro-withdrawing group or a molecular chain having the electro-withdrawing group, and the electro-withdrawing group is a nitro group (—NO₂), a cyano group (—CN), an acetyl group (—COCH₃), a sulfonic acid (—SO₃H), a sulfonyl group (—SO₂CH₃), fluorine (—F), chlorine (—Cl), bromine (—Br), or combinations thereof. At least one of R₁, R₂, and R₃ is halogen or an alkoxy group (—OR, R is C₁-C₄ alkyl group). For example, the silane can be trimethoxy(3,3,3-trifluoropropyl)silane, chloromethyltrimethoxysilane, or 3-(2,4-dinitrophenylamino)propyltriethoxysilane. The silane and the non-carbon inorganic material can be reacted by hydrolysis-condensation or substituent reaction in a gas-phase or liquid-phase to form the non-carbon inorganic material having surface modified by the electron-withdrawing group 13.

In one embodiment, the conductive carbon material 15 and the non-carbon inorganic material having surface modified by the electron-withdrawing group 13 are mixed (as shown in FIG. 2) and have a weight ration of 1:3 to 1:5.

### EXAMPLES

The carbon nanotube in the following examples was a purified single-walled carbon nanotube (SWNT, ASP-100F commercially available from Hanwha nanotech). The SWNT had a purity of 60% to 70% and an average diameter of about 20 nm. An SWNT dispersion was prepared as follows: 0.2 parts by weight of SWNT, 0.2 parts by weight of sodium dedocylbenzene sulfonate, and 100 parts by weight of de-ionized water were mixed and oscillated by a supersonic oscillator (Sonicator 3000 commercially available from Misonix) for 10 minutes to obtain the SWNT dispersion.

The transparency of the transparent conductive film was detected by a visible light of 550 nm, and the transparency of a PET film or a glass substrate served as a background. The sheet resistance of the transparent conductive film was detected by a four-point resistance probe (LORESTA-GP, commercially available from Mitsubishi Chemical Co.)

### Example 1

1.0 g of trimethoxy(3,3,3-trifluoropropyl)silane (commercially available from Sigma-Aldrich), 97.0%, 1.0 g of de-ionized water, and 1 g ethanol were mixed at room temperature for 3 hours to hydrolyze the trimethoxy(3,3,3-trifluoropropyl)silane. 9.4 g of ethanol was added to 5.0 g of SiO₂ sol (ST-NXS, solid content=14.4 wt %, size distribution of 4 nm to 6 nm, commercially available from Nissan Chemical) to form an SiO₂ dispersion (solid content=5.0 wt %). 0.108 g of a hydrolyzed trimethoxy(3,3,3-trifluoropropyl)silane solution was added to the SiO₂ dispersion and stirred at room temperature for 24 hours, thereby obtaining a dispersion of SiO₂ having a surface modified by the trimethoxy(3,3,3-trifluoropropyl)silane, wherein the SiO₂ and the trimethoxy(3,3,3-trifluoropropyl)silane had a weight ratio of 1:0.05.

A PET film having a thickness of 188 μm (A4300, commercially available from Toyobo) served as a substrate. The dispersion of SiO₂ having the surface modified by the trimethoxy(3,3,3-trifluoropropyl)silane was diluted to have a solid content of 1.0 wt %, and the dilution was coated on the substrate by a wire rod (RDS coating Rod #3) in a coater (ZA2300, commercially available from ZEHNTNER). The coating was dried in a cyclic oven of 100° C. 0.5 g of the SWNT dispersion was coated on the dried layer of the SiO₂ having the surface modified by the trimethoxy(3,3,3-trifluoropropyl)silane, and then dried in the cyclic oven of 100° C. The transparent conductive film had a transparency of 91.85% (after deducting the background value) and a sheet resistance of 1,150Ω/□, as tabulated in Table 1.

### Comparative Example 1

The SWNT dispersion was directly coated on the PET film by the wire rod, thereby by forming a wet film having a thickness of 9 μm. The wet film was bake-dried at 100° C. The final transparent conductive film had a transparency of 91.61% (after deducting the background value) and a sheet resistance of 1,700Ω/□, as tabulated in Table 1.

### Example 2

Similar to Example 1, the difference in Example 2 was 0.432 g (not 0.108 g) of a hydrolyzed trimethoxy(3,3,3-trifluoropropyl)silane solution was added to the SiO₂ dispersion. Therefore, the SiO₂ and the trimethoxy(3,3,3-trifluoropropyl)silane had a weight ratio of 1:0.2 in the dispersion of SiO₂ having the surface modified by the trimethoxy(3,3,3-trifluoropropyl)silane. Thereafter, the substrate, the wire rod coating of the dispersion of SiO₂ having the surface modified by the trimethoxy(3,3,3-trifluoropropyl)silane and the SWNT dispersion were similar to that of Example 1. The final transparent conductive film had a transparency of 92.41% (after deducting the background value) and a sheet resistance of 5800M, as tabulated in Table 1.

### Example 3

1 part of the dispersion of SiO₂ having the surface modified by the trimethoxy(3,3,3-trifluoropropyl)silane in Example 2 and 0.1 parts by weight of the SWNT dispersion were mixed, wherein the SWNT and the SiO₂ having the surface modified by the trimethoxy(3,3,3-trifluoropropyl)silane had a weight ratio of 1:3. The substrate was similar to that of Example 1. The mixture was directly coated on the PET substrate by a wire rod, and then bake-dried at 100° C. The final transparent conductive film had a transparency of 92.99% (after deducting the background value) and a sheet resistance of 950Ω/□, as tabulated in Table 1.

### Example 4

After forming the PET substrate/SWNT layer in the Comparative Example 1, the dispersion of SiO₂ having the surface modified by the trimethoxy(3,3,3-trifluoropropyl)silane in Example 2 was further coated on the SWNT layer, and then bake-dried at 100° C. to form a multi-layered structure of the PET substrate/SWNT layer/SiO₂ having the surface modified by the trimethoxy(3,3,3-trifluoropropyl)silane. The final transparent conductive film had a transparency of 93.12% (after deducting the background value) and a sheet resistance of 1,200Ω/□, as tabulated in Table 1.

### Example 5

Similar to Example 2, the difference in Example 5 was that trimethoxy(3,3,3-trifluoropropyl)silane was replaced by chloromethyltrimethoxysilane (commercially available from Sigma-Aldrich, 96%) to modify the silica. Therefore, the SiO₂ and the chloromethyltrimethoxysilane had a weight ratio of 1:0.2 in the dispersion of SiO₂ having the surface modified by the chloromethyltrimethoxysilane. Thereafter, the substrate, the wire rod coating of the dispersion of SiO₂ having the surface modified by the chloromethyltrimethoxysilane and the SWNT dispersion were similar to that of Example 2. The final transparent conductive film had a transparency of 92.15% (after deducting the background value) and a sheet resistance of 1,050Ω/□, as tabulated in Table 1.

### Example 6

Similar to Example 2, the difference in Example 5 was that trimethoxy(3,3,3-trifluoropropyl)silane was replaced by 3-(2,4-dinitrophenylamino)propyltriethoxysilane (commercially available from Gelest, 95%) to modify the silica. Therefore, the SiO₂ and the 3-(2,4-dinitrophenylamino)propyltriethoxysilane had a weight ratio of 1:0.1 in the dispersion of SiO₂ having the surface modified by the 3-(2,4-dinitrophenylamino)propyltriethoxysilane. 1 part of the dispersion of SiO₂ having the surface modified by the 3-(2,4-dinitrophenylamino)propyltriethoxysilane and 0.1 parts by weight of the SWNT dispersion were mixed, wherein the SWNT and the SiO₂ having the surface modified by the 3-(2,4-dinitrophenylamino)propyltriethoxysilane had a weight ratio of 1:3. The substrate was similar to that of Example 1. The mixture was directly coated on the PET substrate by a wire rod, and then bake-dried at 100° C. The final transparent conductive film had a transparency of 93.12% (after deducting the background value) and a sheet resistance of 900Ω/□, as tabulated in Table 1.

### Comparative Example 2

A copper foil was selected as a substrate, dipped in an acetic acid solution for 30 minutes, and then blown dried by nitrogen. The copper foil substrate was set in a tabular furnace. A mixture gas of argon and hydrogen flowed into the furnace, and the furnace was heated to 750° C. Subsequently, methane flowed into the furnace for chemical vapor deposition, thereby preparing a multi-layered graphene film on the copper foil substrate. A PMMA layer was spin-coated on the graphene film. The copper foil was then dissolved by an FeCl₃ solution, and the graphene/PMMA suspended in the FeCl₃ solution was collected by an optical glass. The PMMA was then dissolved and removed by acetone. The graphene was repeatedly washed by ethanol and de-ionized water, and then bake-dried. The conductive graphene film had a transparency of 97.0% (after deducting the background value) and a sheet resistance of 2,700Ω/□, as tabulated in Table 1.

### Example 7

The dispersion of SiO₂ having the surface modified by the trimethoxy(3,3,3-trifluoropropyl)silane in Example 2 was coated on the conductive graphene film in the Comparative Example 2 by a wire rod, and then bake-dried at 100° C. The final transparent conductive film had a transparency of 97.0% (after deducting the background value) and a sheet resistance of 940Ω/□, as tabulated in Table 1.

### Comparative Example 3

1 part by weight of the dispersion of the non-modified SiO₂ in Example 1 and 0.13 parts by weight of the SWNT dispersion in Example 1 were mixed, wherein the SWNT and SiO₂ had a weight ratio of 1:3. The mixture was directly coated on the PET substrate by a wire rod, and then bake-dried at 100° C. The final transparent conductive film had a transparency of 91.73% (after deducting the background value) and a sheet resistance of 2,050Ω/□, as tabulated in Table 1.

TABLE 1

| | Examples | | | | | | | Comparative Examples | | |
|---|---|---|---|---|---|---|---|---|---|---|
| | 1 | 2 | 3 | 4 | 5 | 6 | 7 | 1 | 2 | 3 |
| Transparency | 91.85 | 92.41 | 92.99 | 93.12 | 92.15 | 93.12 | 97.0 | 91.61 | 97.0 | 91.73 |
| (%) | | | | | | | | | | |
| Sheet resistance | 1,150 | 580 | 950 | 1,200 | 1,050 | 900 | 940 | 1,700 | 2,700 | 2,050 |
| (Ω/□) | | | | | | | | | | |

As shown in Table 1, it did not matter whether the non-carbon inorganic material having its surface modified by the electron-withdrawing group was coated under the conductive carbon material, coated on the conductive carbon material, or mixed with the conductive carbon material, the sheet resistance of the conductive carbon material may be reduced. In other words, the non-carbon inorganic having the surface modified by the electron-withdrawing group may increase the conductivity of the conductive carbon material.

### Example 8

Example 2 was repeated, and the final transparent conductive film had a transparency of 92.45% (after deducting the background value) and a sheet resistance of 630Ω/□. The transparent conductive film was put into an oven of 120° C. for 16 hours, and then put at room temperature for 10 minutes to measure its sheet resistance (600Ω/□), as tabulated in Table 2.

### Example 9

Example 3 was repeated, and the final transparent conductive film had a transparency of 92.75% (after deducting the background value) and a sheet resistance of 950Ω/□. The transparent conductive film was put into an oven of 120° C. for 16 hours, and then put at room temperature for 10 minutes to measure its sheet resistance (900Ω/□), as tabulated in Table 2.

### Example 10

Example 4 was repeated, and the final transparent conductive film had a transparency of 93.05% (after deducting the background value) and a sheet resistance of 1100Ω/□. The transparent conductive film was put into an oven of 120° C. for 16 hours, and then put at room temperature for 10 minutes to measure its sheet resistance (980Ω/□), as tabulated in Table 2.

### Comparative Example 4

Comparative Example 1 was repeated, and the final transparent conductive film had a transparency of 91.81% (after deducting the background value) and a sheet resistance of 1800Ω/□. The transparent conductive film was put into an oven of 120° C. for 16 hours, and then put at room temperature for 10 minutes to measure its sheet resistance (1680Ω/□), as tabulated in Table 2.

### Comparative Example 5

Comparative Example 1 was repeated, and the final transparent conductive film had a transparency of 91.74% (after deducting the background value) and a sheet resistance of 1300Ω/□. The transparent conductive film was dipped in a concentrated nitric acid solution for 30 minutes, and then washed by de-ionized water to remove the nitric acid remained on the transparent conductive film surface. The transparent conductive film was put into an oven of 100° C. for 10 minutes, and then put at room temperature for 10 minutes to measure its sheet resistance (350Ω/□). The transparent conductive film was then put into an oven of 120° C. for 16 hours, and then put at room temperature for 10 minutes to measure its sheet resistance (1150Ω/□), as tabulated in Table 2.

TABLE 2

| | | | | Comparative | Comparative |
|---|---|---|---|---|---|
| | Example 8 | Example 9 | Example 10 | Example 4 | Example 5 |
| Initial transparency (%) | 92.45 | 92.75 | 93.05 | 91.81 | 91.74 |
| Initial sheet resistance (Ω/□) | 630 | 950 | 1,100 | 1,800 | 350 |
| Sheet resistance after 120° C./16 | 600 | 900 | 980 | 1,680 | 1,150 |
| hours (Ω/□) | | | | | |
| Sheet resistance change | −4.76% | −5.26% | −10.91% | −6.67% | 228.57% |

As shown in Table 2, the non-carbon inorganic having the surface modified by the electron-withdrawing group not only reduced the sheet resistance of the transparent conductive film, but also kept the sheet resistance of the transparent conductive film after baking the film at high temperature for a long period. The carbon nanotube doped with nitric acid may largely reduce the sheet resistance of the transparent conductive film, however, it would not keep the sheet resistance of the transparent conductive film after baking the film at high temperature for a long period.

### Example 11

Example 2 was repeated, and the final transparent conductive film had a transparency of 92.45% (after deducting the background value) and a sheet resistance of 630Ω/□. The transparent conductive film was put into an oven of 85° C. and 100% RH (relative humidity) for 16 hours, then put into an oven of 100° C. for 30 minutes to bake-dry, and then put at room temperature for 10 minutes to measure its sheet resistance (610Ω/□), as tabulated in Table 3.

### Example 12

Example 3 was repeated, and the final transparent conductive film had a transparency of 92.75% (after deducting the background value) and a sheet resistance of 950Ω/□. The transparent conductive film was put into an oven of 85° C. and 100% RH (relative humidity) for 16 hours, then put into an oven of 100° C. for 30 minutes to bake-dry, and then put at room temperature for 10 minutes to measure its sheet resistance (890Ω/□), as tabulated in Table 3.

### Example 13

Example 4 was repeated, and the final transparent conductive film had a transparency of 93.05% (after deducting the background value) and a sheet resistance of 1100Ω/□. The transparent conductive film was put into an oven of 85° C. and 100% RH (relative humidity) for 16 hours, then put into an oven of 100° C. for 30 minutes to bake-dry, and then put at room temperature for 10 minutes to measure its sheet resistance (965Ω/□), as tabulated in Table 3.

### Comparative Example 6

Comparative Example 1 was repeated, and the final transparent conductive film had a transparency of 91.81% (after deducting the background value) and a sheet resistance of 1800Ω/□. The transparent conductive film was put into an oven of 85° C. and 100% RH (relative humidity) for 16 hours, then put into an oven of 100° C. for 30 minutes to bake-dry, and then put at room temperature for 10 minutes to measure its sheet resistance (1600Ω/□), as tabulated in Table 3.

TABLE 3

| | | | | Com- |
|---|---|---|---|---|
| | | | | parative |
| | Example 11 | Example 12 | Example 13 | Example 6 |
| Initial sheet | 630 | 950 | 1,100 | 1,800 |
| resistance (Ω/□) | | | | |
| Sheet resistance | 610 | 890 | 965 | 1,600 |
| after 85° C./ | | | | |
| 100RH/16 hours | | | | |
| (Ω/□) | | | | |

As shown in Table 3, the non-carbon inorganic having the surface modified by the electron-withdrawing group not only reduced the sheet resistance of the transparent conductive film, but also kept the sheet resistance of the transparent conductive film after baking the film at high humidity and high temperature for a long period.

### Example 14

Example 2 was repeated, and the final transparent conductive film had a transparency of 92.2% (after deducting the background value) and a sheet resistance of 560Ω/□. The transparent conductive film was washed by ethanol and then bake-dried to measure its sheet resistance (530Ω/□), as tabulated in Table 4.

### Example 15

Example 3 was repeated, and the final transparent conductive film had a transparency of 93.15% (after deducting the background value) and a sheet resistance of 1000Ω/□. The transparent conductive film was washed by ethanol and then bake-dried to measure its sheet resistance (925Ω/□), as tabulated in Table 4.

### Example 16

Example 4 was repeated, and the final transparent conductive film had a transparency of 93.31% (after deducting the background value) and a sheet resistance of 1,300Ω/□. The transparent conductive film was washed by ethanol and then bake-dried to measure its sheet resistance (1,200Ω/□), as tabulated in Table 4.

### Comparative Example 7

Comparative Example 1 was repeated, and the final transparent conductive film had a transparency of 91.53% (after deducting the background value) and a sheet resistance of 1,350Ω/□. Bis(trifluoromethanesulfonyl)amine (commercially available from Sigma-Aldrich, ≧95.0%) was dissolved in ethanol to prepare an ethanol solution (0.05 wt %). The ethanol solution was spin-coated (1000 rpm for 30 seconds) on the transparent conductive film of Comparative Example 1 and then bake-dried, thereby forming a transparent conductive film of the carbon nanotube doped with bis(trifluoromethanesulfonyl)amine. The transparent conductive of the doped carbon nanotube had a sheet resistance of 400Ω/□. The transparent conductive of the doped carbon nanotube was put at room temperature for 15 days to measure its sheet resistance (425Ω/□). Thereafter, the transparent conductive of the doped carbon nanotube was washed by ethanol and then bake-dried to measure its sheet resistance (710Ω/□), as tabulated in Table 4.

TABLE 4

| | | | | Com- |
|---|---|---|---|---|
| | | | | parative |
| | Example 14 | Example 15 | Example 16 | Example 7 |
| Transparency (%) | 92.2 | 93.15 | 93.31 | 91.8 |
| Sheet resistance | 560 | 1,000 | 1,300 | 425 |
| (Ω/□) | | | | |
| Sheet resistance | 530 | 925 | 1,200 | 710 |
| after ethanol | | | | |
| washing | | | | |
| Sheet resistance | −5.36% | −7.5% | −7.69% | +67.59% |
| change | | | | |

The small molecular dopant bis(trifluoromethanesulfonyl)amine in the Comparative Example 7 had strong oxidative ability, and its anion (CF₃SO₂)₂N⁻ had low volatility, hydrophobic property, and electro-withdrawing group for a stable p-type doping effect at room temperature. However, the carbon nanotube doped with bis(trifluoromethanesulfonyl)amine could not resist the solvent washing. The transparent conductive film in the disclosure, composed of the conductive carbon material contacting the non-carbon inorganic material having the surface modified by the electron-withdrawing group, kept its sheet resistance properties after ethanol washing. Accordingly, the non-carbon inorganic material having the surface modified by the electron-withdrawing group should resist from the solvent washing. The modified SiO₂ still contacted the nano carbon material, such that the p-type doping effect was kept.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A transparent conductive film, comprising:
a substrate; and
a conductive composite on the substrate,
wherein the conductive composite includes:
a conductive carbon material; and
a non-carbon inorganic material having surface modified by an electron-withdrawing group, wherein the conductive carbon material contacts the non-carbon inorganic material having surface modified by the electron-withdrawing group.

2. The transparent conductive film as claimed in claim 1, wherein the conductive carbon material and the non-carbon inorganic material having surface modified by the electron-withdrawing group are mixed or arranged as a layered structure to form the conductive composite.

3. The transparent conductive film as claimed in claim 1, wherein the conductive carbon material and the non-carbon inorganic material having surface modified by the electron-withdrawing group are alternately arranged as layered structure to form the conductive composite.

4. The transparent conductive film as claimed in claim 1, wherein the conductive carbon material comprises carbon nanotube, graphene, graphene oxide, graphene nanoribbon, or combinations thereof.

5. The transparent conductive film as claimed in claim 1, wherein the non-carbon inorganic material having surface modified by the electron-withdrawing group has a shape of a pellet, a sheet, a mesh, a film, or combinations thereof.

6. The transparent conductive film as claimed in claim 1, wherein the non-carbon inorganic material having surface modified by the electron-withdrawing group includes oxide, silicate, hydroxide, carbonate, sulfate, phosphate, sulfide, or combinations thereof of silicon, tin, titanium, zinc, aluminum, zirconium, indium, antimony, tungsten, yttrium, magnesium, or cerium having surface modified by the electron-withdrawing group.

7. The transparent conductive film as claimed in claim 1, wherein the non-carbon inorganic material having surface modified by the electron-withdrawing group is formed by grafting a silane having the electro-withdrawing group on the surface of the non-carbon inorganic material,
wherein the silane having the electro-withdrawing group has a formula of X—Si(R₁)(R₂)(R₃),
X is the electro-withdrawing group or a molecular chain having the electro-withdrawing group,
at least one of R₁, R₂, and R₃ is halogen or an alkoxy group (—OR, R is C₁-C₄ alkyl group), and
the electro-withdrawing group is a nitro group (—NO₂), a cyano group (—CN), an acetyl group (—COCH₃), a sulfonic acid (—SO₃H), a sulfonyl group (—SO₂CH₃), fluorine (—F), chlorine (—Cl), bromine (—Br), or combinations thereof.

8. The transparent conductive film as claimed in claim 7, wherein the silane having the electro-withdrawing group is trimethoxy(3,3,3-trifluoropropyl)silane, chloromethyltrimethoxysilane, or 3-(2,4-dinitrophenylamino)propyltriethoxysilane.

9. The transparent conductive film as claimed in claim 1, wherein the conductive carbon material and the non-carbon inorganic material having surface modified by the electron-withdrawing group are mixed to form the conductive composite, and the conductive carbon material and the non-carbon inorganic material having surface modified by the electron-withdrawing group have a weight ratio of 1:3 to 1:5.

10. A method of forming a transparent conductive film, comprising:
providing a substrate; and
forming a conductive composite on the substrate,
wherein the conductive composite includes:
a conductive carbon material; and
a non-carbon inorganic material having surface modified by an electron-withdrawing group, wherein the conductive carbon material contacts the non-carbon inorganic material having surface modified by the electron-withdrawing group.

11. The method as claimed in claim 10, wherein the conductive carbon material and the non-carbon inorganic material having surface modified by the electron-withdrawing group are mixed or arranged as a layered structure to form the conductive composite.

12. The method as claimed in claim 10, wherein the non-carbon inorganic material having surface modified by the electron-withdrawing group is formed by reacting a silane having the electro-withdrawing group and the non-carbon inorganic material by a hydrolysis-condensation or substituent reaction in a gas-phase or a liquid-phase.

13. The method as claimed in claim 10, wherein the conductive carbon material and the non-carbon inorganic material having surface modified by the electron-withdrawing group are alternately arranged as a layered structure to form the conductive composite.

14. The method as claimed in claim 10, wherein the non-carbon inorganic material having surface modified by the electron-withdrawing group includes oxide, silicate, hydroxide, carbonate, sulfate, phosphate, sulfide, or combinations thereof of silicon, tin, titanium, zinc, aluminum, zirconium, indium, antimony, tungsten, yttrium, magnesium, or cerium having surface modified by the electron-withdrawing group.

15. The method as claimed in claim 12, wherein the silane having the electro-withdrawing group has a formula of X—Si(R₁)(R₂)(R₃),
X is the electro-withdrawing group or a molecular chain having the electro-withdrawing group,
at least one of R₁, R₂, and R₃ is halogen or an alkoxy group (—OR, R is C₁-C₄ alkyl group), and
the electro-withdrawing group is a nitro group (—NO₂), a cyano group (—CN), an acetyl group (—COCH₃), a sulfonic acid (—SO₃H), a sulfonyl group (—SO₂CH₃), fluorine (—F), chlorine (—Cl), bromine (—Br), or combinations thereof.

16. The method as claimed in claim 15, wherein the silane having the electro-withdrawing group is trimethoxy(3,3,3-trifluoropropyl)silane, chloromethyltrimethoxysilane, or 3-(2,4-dinitrophenylamino)propyltriethoxysilane.

17. The method as claimed in claim 10, wherein the step of forming the conductive composite on the substrate comprises coating, transfer printing, or vapor depositing.
